(19) United States
(12) Patent Application Publication
(10) Pub. No.: US 2013/0197780 A1
(43) Pub. Date: Aug. 1, 2013

(54) SUPERVISORY CONTROL SYSTEM FOR SERIES TYPE HYBRID-ELECTRIC POWERTRAINS

(71) Applicant: Dale A. Oehlerking, St. Charles, IL (US)

(72) Inventor: Dale A. Oehlerking, St. Charles, IL (US)

(21) Appl. No.: 13/877,815

(22) PCT Filed: Oct. 8, 2010
(86) PCT No.: PCT/US10/51949

§ 371 Date: Apr. 4, 2013

(51) Int. Cl. F02D 35/00

(52) U.S. Cl. CPC F02D 35/00
USPC 701/102

(57) ABSTRACT

A method of operating a series type hybrid-electric powertrain having an internal combustion engine, a generator, and a battery is provided. A state of charge level of a battery is estimated. The state of charge level estimate is compared to a first threshold. An internal combustion engine operates at a first engine speed setpoint and a first engine torque output setpoint when the state of charge level estimate is below the first threshold. The state of charge level estimate is compared to a second threshold. The second threshold is a lower state of charge level than the first threshold. The internal combustion engine operates at a second engine speed setpoint and a second engine torque output setpoint when the state of charge level estimate is below the second threshold. The internal combustion engine generates more torque at the second torque output setpoint.

### TECHNICAL FIELD

The present disclosure relates to a control system for a hybrid-electric powertrain, and more particularly to a supervisory control system for series-type hybrid-electric powertrains.

### BACKGROUND

Many vehicles now utilize hybrid-electric powertrains in order to increase the efficiency of the vehicle. Hybrid-electric powertrains typically may be classified as being either a series type hybrid, or a parallel type hybrid.

In a parallel type hybrid, or parallel hybrid, has a mechanical connection that exists between an internal combustion engine and drive wheels of a vehicle. The parallel type hybrid typically has an electric motor that is used to supplement the power output by the internal combustion engine. A generator is also mechanically connected to the internal combustion engine to provide electrical power for use by electric motors that may be used to at least partially power drive wheels of the vehicle. It is also common to have a battery pack for storing some electrical energy. In some instances hydraulic motors are utilized in place of the electric motors in a parallel-type hybrid. In such a configuration a hydraulic pump would be utilized in place of a generator, and hydraulic accumulators may be used to store pressurized hydraulic fluid for use by the hydraulic motors.

In a series type hybrid, or series hybrid, no mechanical connection exists between an internal combustion engine and drive wheels of a vehicle. Instead, an internal combustion engine typically is mechanically connected to a generator that generates electrical power to be utilized by electric motors that power drive wheels of the vehicle. It is common to have a battery back so that some electrical energy may be stored. In some instances hydraulic motors can also be used in place of the electric motors in a series-type hybrid. In such a configuration a hydraulic pump would be utilized in place of a generator, and hydraulic accumulators may be used to store pressurized hydraulic fluid for use by the hydraulic motors.

While parallel-type hybrids are widely used in automotive applications, such as passenger cars, series-type hybrids are less commonly employed. However, one advantage of a series-type hybrid is that since the engine is not mechanically connected to the drive wheels, there is not a requirement to coordinate engine speed to road speed. Therefore, an internal combustion engine may be operated in a way that is deemed beneficial. Therefore, a need exists to control an internal combustion engine in a manner appropriate for operating conditions a vehicle is experiencing.

### SUMMARY

According to one process, a method of operating a series type hybrid-electric powertrain having an internal combustion engine, a generator, and a battery is provided. A state of charge level of a battery is estimated. The state of charge level estimate is compared to a first threshold. An internal combustion engine operates at a first engine speed setpoint and a first engine torque output setpoint when the state of charge level estimate is below the first threshold. The state of charge level estimate is compared to a second threshold. The second threshold is a lower state of charge level than the first threshold. The internal combustion engine operates at a second engine speed setpoint and a second engine torque output setpoint when the state of charge level estimate is below the second threshold. The internal combustion engine generates more torque at the second torque output setpoint.

According to one embodiment, a physical computer program product, comprising a computer usable medium having an executable computer readable program code embodied therein, the executable computer readable program code for implementing a method of operating a vehicle having a series type hybrid-electric powertrain having an internal combustion engine, a generator, and a battery. The method estimates a state of charge level of a battery. The state of charge level estimate is compared to a first threshold. An internal combustion engine operates at a first engine speed setpoint and a first engine torque output setpoint when the state of charge level estimate is below the first threshold. The state of charge level estimate is compared to a second threshold, the second threshold being a lower state of charge level than the first threshold. The internal combustion engine operates at a second engine speed setpoint and a second engine torque output setpoint when the state of charge level estimate is below the second threshold. The internal combustion engine generates more torque at the second torque output setpoint.

According to another process, a method of operating a generator of a series type hybrid-electric powertrain to control output of an internal combustion engine of the series type hybrid-electric powertrain, the internal combustion engine coupled to an electric generator, is provided. The method receives a desired torque output setting for an internal combustion engine. A desired engine speed setting for the internal combustion engine is received. A voltage setting for a generator of the series type hybrid-electric powertrain is received. A first current output setting is generated for the generator for the series type hybrid-electric powertrain based upon the desired torque output setting, the desired engine speed setting, and the voltage setting.

### BRIEF DESCRIPTION OF THE DRAWINGS

FIG. 1 is a brake specific fuel consumption map for an internal combustion engine.

FIG. 2 is a NO_{X} emission map for the internal combustion engine of FIG. 1.

FIG. 3 is a NO_{X} emission map for the internal combustion engine of FIG. 1 showing a first operating point adapted to limit emissions and a second operating point adapted for higher power operation.

FIG. 4 is a schematic diagram showing a method of controlling an internal combustion engine and a generator for a vehicle having a series-type hybrid electric powertrain.

### DETAILED DESCRIPTION

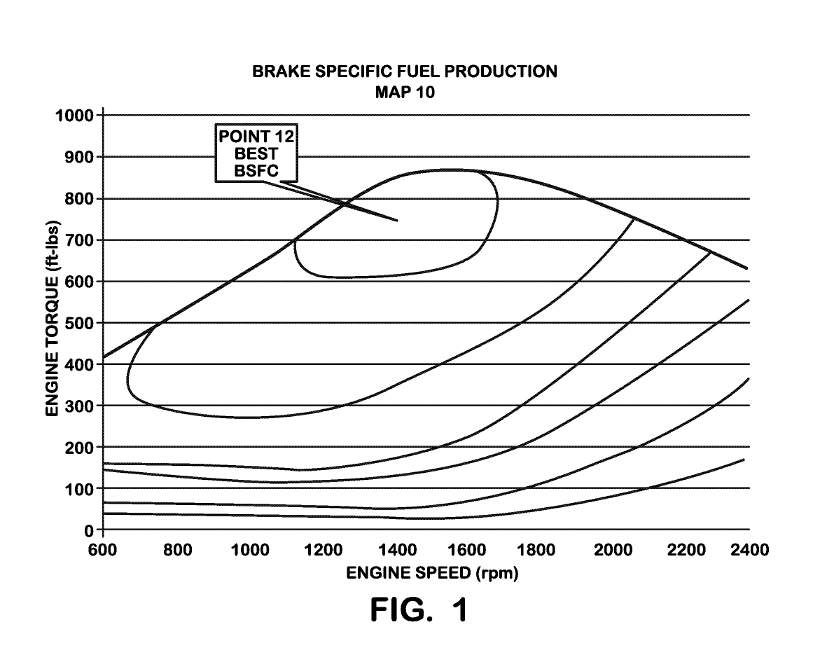

Referring now to the figures and in particular to FIG. 1, a brake specific fuel consumption map 10 is shown for an internal combustion engine. The brake specific fuel consumption map 10 shows a torque curve for the internal combustion engine and further contains a number of curves that indicate fuel consumption on the basis of pounds of fuel per horsepower-hour required to operate the engine. A point 12 on the map 10 indicates an optimal engine operating condition for least fuel consumption based on power output of the engine. As shown in FIG. 1, the most fuel efficient operating point 12 of the engine occurs at an engine speed of about 1250 rpm and with an engine torque output of about 740 pound-feet. As can be seen in FIG. 1, the internal combustion engine operates most efficiently, from a fuel consumption perspective, at a relatively high load and a relatively low speed. The internal combustion engine is least efficient at low loads and relatively high speeds.

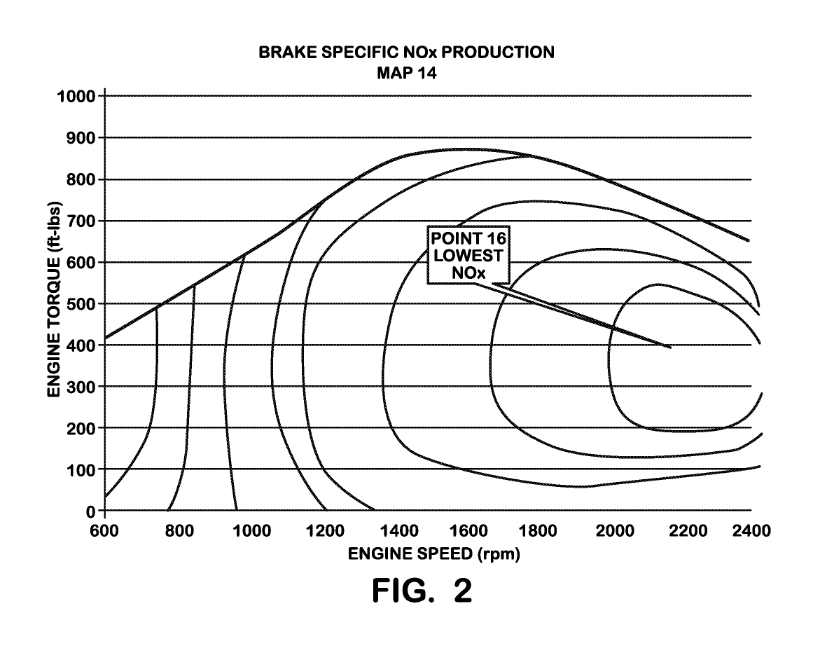

Turning now to FIG. 2, a nitrogen oxides (“NO_{X}”) emissions map for the internal combustion engine of FIG. 1 is shown. The NO_{X} emissions map shows the torque curve for the internal combustion engine and further contains a number of curves that indicate NO_{X} emissions output of the internal combustion engine on a grams per horsepower-hour basis. A point 16 on the map 14 indicates an optimal engine operating condition for lowest NO_{X} emissions. As shown in FIG. 2, the operating point 16 of the internal combustion engine that generates the lowest NO_{X} emissions occurs at an engine speed of about 2100 rpm and with an engine torque output of about 350 pound-feet. Thus, the internal combustion engine operates with lowest NO_{X} emissions at a relatively high speed and a relatively low load, conditions generally opposite those shown in FIG. 1 for lowest fuel consumption.

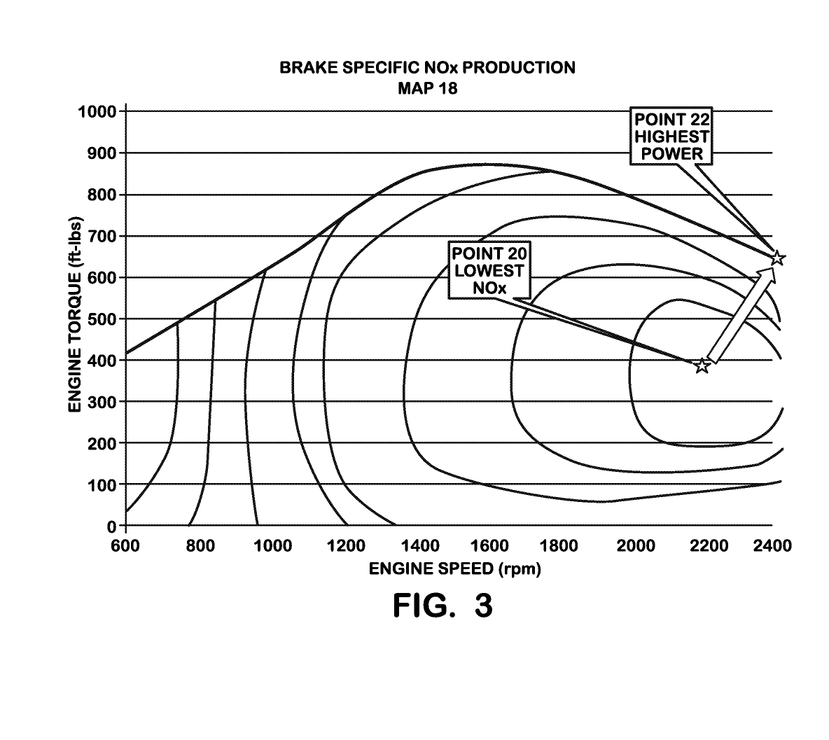

Thus, as indicated by the fuel consumption map 10 of FIG. 1 and the NO_{X} emissions map 14 of FIG. 2, the internal combustion engine of FIGS. 1 and 2 operates in a way that produces more NO_{X} emissions when fuel economy is optimized, and uses more fuel and generates little power when NOₓ emissions are optimized. Therefore, in order to minimize NO_{X} emissions, but allow a vehicle to have sufficient power output to be used in situations where a vehicle having a series hybrid-electric powertrain requires additional power output, a control algorithm is utilized to allow the internal combustion engine of the series-type hybrid to select operating points appropriate for power required by a vehicle. FIG. 3 shows a NO_{X} emissions map 18 for the internal combustion engine of FIG. 1 and FIG. 2. A first engine operating point 20 and a second engine operating point 22 are disclosed on the NO_{X} emissions map 18. The first engine operating point 20 is adapted to operate the engine in a manner to limit NO_{X} emissions, but will produce a low power output. The first engine operating point 20 is suited for many vehicle operating conditions, such as steady state highway operations where the vehicle is maintained at a generally constant speed and on generally level ground.

The second engine operating point 22 shown on the NO_{X} emissions map 18 is adapted to operate the engine in a manner that produces more power, but increases the NO_{X} emissions of the engine. The second engine operating point 22 is suited for vehicle operating conditions where additional power output is required of the engine, such as climbing a grade or rapid acceleration. The additional power output of the engine allows the series hybrid-electric powertrain to provide acceptable performance, but also maintain relatively low emissions and offer fuel efficient engine operation.

As the series type hybrid-electric vehicle typically utilizes electric motors to power the drive wheels of the vehicle, batteries are often utilized to store electrical power to be used by the electric motors, and the internal combustion engine drives a generator that generates electrical power utilized by the electric motors and stored by the batteries. It is contemplated in some embodiments that the batteries will always be used to provide electrical power to the electric motors, and that electrical power produced by the generator powered by the internal combustion engine is always provided to the batteries, rather than being directly provided to the electric motors. Thus, charge level of the batteries is monitored to determine when the internal combustion engine is required to be run to allow the generator to produce electrical power to recharge the batteries to an acceptable charge level, or to raise the charge within the batteries above the acceptable charge level. Therefore, the engine may only need to be operated when the battery is below a predetermined state of charge level.

Once the battery is determined to be below the predetermined state of charge level, the internal combustion engine is started to drive the generator to produce electrical power supplied to the battery. The internal combustion engine is initially operated at the first operating point 20 of FIG. 3. If the charge level of the battery is not maintained at the first operating point 20 of FIG. 3, the internal combustion engine is operated at the second operating point 22 of FIG. 3. Once the battery charge is above the predetermined state of charge level, the internal combustion engine may be shut off until the battery state of charge once again falls below the predetermined state of charge level.

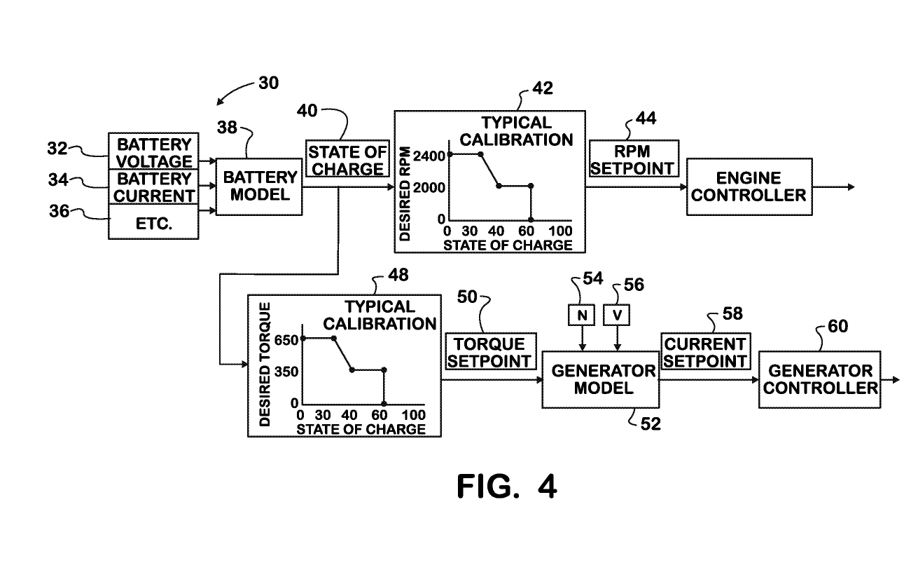

FIG. 4 shows a schematic diagram 30 of operating an internal combustion engine of a vehicle having a series type hybrid-electric powertrain. The schematic diagram 30 depicts a method for determining operating conditions for an internal combustion engine and a generator for a series type hybrid-electric powertrain. A battery voltage 32, a battery current 34 and other battery information 36 are fed into a battery model 38. The battery voltage 32 and the battery current 34 are measured by sensors in the electrical system of the series type hybrid-electric powertrain. The other battery information 36 may include information such as ambient temperature, battery age, a number of charge cycles the battery has experienced, and other known factors that may affect battery performance. The battery model 38 is based upon experimental data and utilizes the inputs 32-36 to generate a state of charge level estimate 40 for the battery. The state of charge level estimate 40 indicates what percentage of maximum charge the battery has at that instant.

The state of charge level estimate 40 is utilized in an engine speed determination module 42. The engine speed determination module 42 generates an engine speed setpoint 44 based upon the state of charge level estimate 40. The engine speed determination module 40 shows that the engine is not operated until the state of battery charge is below a predetermined threshold of 60%, and then the engine will operate at the first setpoint 20 of FIG. 3 until the state of charge level estimate 40 falls below a second predetermined threshold of 40%, where the engine will transition to the second setpoint 22 of FIG. 3. The engine speed setpoint 44 is sent to an engine controller 46 in order to operate the engine at the engine speed setpoint 44.

The state of charge level estimate 40 is additionally utilized in an engine torque output determination module 48. The engine torque output determination module 48 generates an engine torque output setpoint 50 based upon the state of charge level estimate 40. The engine torque output determination module 48 shows that the engine is not operated until the state of battery charge is below a predetermined threshold of 60%, and then the engine will operate at the first setpoint 20 of FIG. 3 until the state of charge level estimate 40 falls below a second predetermined threshold of 40%, where the engine will transition to the second setpoint 22 of FIG. 3. The engine torque output setpoint 50 is utilized by a generator model 52.

The generator model 52 is utilized to set a load so that the engine operates at the speed setpoint 44 and with the torque output setpoint 50. As a generator provides the load to an internal combustion engine in a series type hybrid-electric powertrain, the generator model is utilized to determine the load that the generator must place on the internal combustion engine. The generator model 52 must express the load that the generator places on the internal combustion engine as a function of torque. Thus, the following formula is utilized to determine a current that the generator will have as an output in order to utilize the desired torque output setpoint 50 of the engine:

Power Out=(Power In) (Efficiency)

Pₒᵤₜ=(I)(V)=[(T)(N)(η)/5252](k)

I=(T)(N)(k)(η)/5252(V)

### Where:

T=Desired torque (ft-lbs)
V=System voltage
N=Engine speed (rpm)
I=Generator output current (amps)
η=Generator efficiency
k=kW-to-horsepower conversion factor (0.7457)

Thus, the final equation for the generator model utilizes the engine speed setpoint 44 as the engine speed N, the engine torque output setpoint 50 as the desired torque T, and V will be known based upon the electrical system of the vehicle having the series type hybrid-electric powertrain. Thus, the generator model 52 determines a current setpoint 58 based upon the engine speed setpoint 44, shown entering the generator model 52 at block 54, the known electrical system voltage 56, and the engine torque output setpoint 50. The current setpoint 58 is transmitted to a generator controller 60 to adjust the generator such that the current setpoint 58 is produced by the generator of the hybrid-electric powertrain.

As shown in the engine speed determination module 42 and the engine torque output determination module 48 of FIG. 4, the battery state of charge level range when the internal combustion engine will operate is when the battery model 38 generates a state of charge level estimate 40 of less than about 60%. Thus, if the battery has a state of charge level 40 of more than about 60%, the internal combustion engine will not operate. Additionally, if operating the internal combustion engine at the first setpoint 20 of FIG. 3 is not sufficient to maintain the state of charge level 40 of the battery above about 40%, the internal combustion engine will be operated at the second setpoint 22 of FIG. 3 until the state of charge level 40 is above about 30%. When the state of charge level 40 is between about 30% and 40%, the internal combustion engine will be operated in a manner to transition between the second setpoint 22 and the first setpoint 20 of FIG. 3. Once the battery state of charge level 40 exceeds about 60%, the internal combustion engine shuts off, and the series type hybrid-electric powertrain operates only on battery power. Maintaining the battery state of charge level 40 within a more narrow range improves battery life, reducing service and maintenance expenses of the series type hybrid-electric powertrain.

It will be understood that a control system may be implemented in hardware to effectuate the method. The control system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

When the control system is implemented in software, it should be noted that the control system can be stored on any computer readable medium for use by or in connection with any computer related system or method. In the context of this document, a computer-readable medium can be any medium that can store, communicate, propagate, or transport the program for use by or in connection with the instruction execution system, apparatus, or device. The computer readable medium can be, for example, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). The control system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

What is claimed is:

1. A method of operating a series type hybrid-electric powertrain having an internal combustion engine, a generator, and a battery, the method comprising:
estimating a state of charge level of a battery;
comparing the estimated state of charge level to a first threshold;
operating an internal combustion engine at a first engine speed setpoint and a first engine torque output setpoint when the estimated state of charge level is below the first threshold;
comparing the estimated state of charge level to a second threshold, the second threshold being a lower state of charge level than the first threshold; and
operating the internal combustion engine at a second engine speed setpoint and a second engine torque output setpoint when the estimated state of charge level is below the second threshold, wherein the internal combustion engine generates more torque at the second torque output setpoint.

2. The method of operating a series type hybrid-electric powertrain having an internal combustion engine, a generator, and a battery of claim 1, wherein the generator provides a load on the internal combustion engine to operate the engine at one of the first engine speed setpoint and the second engine speed setpoint.

3. The method of operating a series type hybrid-electric powertrain having an internal combustion engine, a generator, and a battery of claim 1, wherein the first threshold state of charge level is about 60% of total charge.

4. The method of operating a series type hybrid-electric powertrain having an internal combustion engine, a generator, and a battery of claim 1, wherein the second threshold state of charge level is about 30% of total charge.

5. The method of operating a series type hybrid-electric powertrain having an internal combustion engine, a generator, and a battery of claim 1, wherein the first engine torque output setpoint is about 350 pound-feet.

6. The method of operating a series type hybrid-electric powertrain having an internal combustion engine, a generator, and a battery of claim 1, wherein the first engine torque output setpoint is about 650 pound-feet.

7. The method of operating a series type hybrid-electric powertrain having an internal combustion engine, a generator, and a battery of claim 1, wherein the first engine speed setpoint and the first engine torque output setpoint are selected based on engine NO_{X} emissions levels.

8. The method of operating a series type hybrid-electric powertrain having an internal combustion engine, a generator, and a battery of claim 1, wherein the second engine speed setpoint and the second engine torque output setpoint are selected based on brake specific fuel consumption.

9. The method of operating a series type hybrid-electric powertrain having an internal combustion engine, a generator, and a battery of claim 1, wherein the second engine speed setpoint and the second engine torque output setpoint have a lower brake specific fuel consumption than the first engine speed setpoint and the first engine torque output setpoint.

10. A physical computer program product, comprising a computer usable medium having an executable computer readable program code embodied therein, the executable computer readable program code for implementing a method of operating a vehicle having a series type hybrid-electric powertrain having an internal combustion engine, a generator, and a battery, the method comprising:
estimating a state of charge level of a battery;
comparing the estimated state of charge level to a first threshold;
operating an internal combustion engine at a first engine speed setpoint and a first engine torque output setpoint when the estimated state of charge level is below the first threshold;
comparing the estimated state of charge level to a second threshold, the second threshold being a lower state of charge level than the first threshold; and
operating the internal combustion engine at a second engine speed setpoint and a second engine torque output setpoint when the estimated state of charge level is below the second threshold, wherein the internal combustion engine generates more torque at the second torque output setpoint.

11. The physical computer program product of claim 10, wherein the generator current output is controlled to provide a load on the internal combustion engine to operate the engine at one of the first engine speed setpoint and the second engine speed setpoint.

12. The physical computer program product of claim 10, wherein the first state of charge level threshold is about 60% of total charge.

13. The physical computer program product of claim 10, wherein the second state of charge level threshold is about 30% of total charge.

14. The physical computer program product of claim 10, wherein the engine is not operated when the estimated state of charge level is above the first threshold.

15. The physical computer program product of claim 10, wherein the first engine speed setpoint and the first engine torque output setpoint are selected based on engine NO_{X} emissions levels.

16. The physical computer program product of claim 10, wherein the second engine speed setpoint and the second engine torque output setpoint are selected based on brake specific fuel consumption.

17. A method of operating a generator of a series type hybrid-electric powertrain to control output of an internal combustion engine of the series type hybrid-electric powertrain, the internal combustion engine coupled to an electric generator, the method comprising:
receiving a desired torque output setting for an internal combustion engine;
receiving a desired engine speed setting for the internal combustion engine;
receiving a voltage setting for a generator of the series type hybrid-electric powertrain; and
generating a first current output setting for the generator for the series type hybrid-electric powertrain based upon the desired torque output setting, the desired engine speed setting, and the voltage setting.

18. The method of operating a generator of a series type hybrid-electric powertrain to control output of an internal combustion engine of the series type hybrid-electric powertrain of claim 17, wherein the desired torque setting is based on a battery state of charge level.

19. The method of operating a generator of a series type hybrid-electric powertrain to control output of an internal combustion engine of the series type hybrid-electric powertrain of claim 17, wherein the desired torque output setting and the desired engine speed setting correspond to one of a first engine operating setpoint and a second engine operating setpoint.

20. The method of operating a generator of a series type hybrid-electric powertrain to control output of an internal combustion engine of the series type hybrid-electric powertrain of claim 19, wherein the first engine operating setpoint is an emissions limiting setpoint and the second engine operating setpoint is a fuel consumption limiting setpoint.
